(19) United States
(12) Patent Application Publication
(10) Pub. No.: US 2026/0153970 A1
(43) Pub. Date: Jun. 4, 2026

(54) METHODS FOR MANAGING HAND INTERACTION OF USER ON SCREEN OF ELECTRONIC DEVICE

(71) Applicant: Samsung Electronics Co., Ltd., Suwon-si (KR)

(72) Inventors: Bindigan Hariprasanna PAWAN PRASAD, Bangalore (IN); Green Rosh K S, Bangalore (IN); Vishakha S R, Bangalore (IN); Anoop Kolar RAJAGOPAL, Bangalore (IN); Meghana SHANKAR, Bangalore (IN)

(21) Appl. No.: 19/456,521

(22) Filed: Jan. 22, 2026

Related U.S. Application Data
(63) Continuation of application No. PCT/KR2025/018304, filed on Nov. 7, 2025.

(30) Foreign Application Priority Data
Nov. 14, 2024 (IN) 202441088300
Sep. 23, 2025 (IN) 2024 41088300

(51) Int. Cl. G06F 3/04812; G06F 3/01; G06F 3/04842

(52) U.S. Cl. CPC G06F 3/04812; G06F 3/013; G06F 3/017; G06F 3/04842

(57) ABSTRACT

A method performed by an electronic device may be provided. The method may include comparing original hand data and perceived hand data to identify at least one uncertain input zone. The method may include identifying a pointer indicating a finger of a user pointing towards at least one a first UI element, or a second UI element in the at least one identified uncertain zone. The method may include modifying a size of the pointer based on a size of the at least one identified uncertain zone. The method may include determining an extent of an overlap of the pointer with at least one of the first UI element, or the second UI element. The method may include selecting and activating at least one of the first UI element, or the second UI element that has a maximum overlap with the pointer.

### CROSS-REFERENCE TO RELATED APPLICATION(S)

This application is a continuation application, claiming priority under 35 U.S.C. § 365(c), of an International application No. PCT/KR2025/018304, filed on Nov. 7, 2025, which is based on and claims the benefit of an Indian Provisional patent application number 202441088300, filed on Nov. 14, 2024, in the Indian Intellectual Property Office, and of an Indian Complete patent application number 202441088300, filed on Sep. 23, 2025, in the Indian Intellectual Property Office, the disclosure of each of which is incorporated by reference herein in its entirety.

### BACKGROUND

### 1. Field

The disclosure relates to a field of an extended reality (XR) technology. More particularly, the disclosure relates to a method and an electronic device for managing hand interaction of a user on a screen of the electronic device in an XR environment.

### 2. Description of Related Art

A user with eye power is expected to use prescription (Rx) inserts for seamless visual experience on a head mounted display (HMD). When the user does not use the Rx inserts or if the used Rx insert is defective, the user experience is deteriorated. This mainly results in poor interactions, where the HMD does not detect the user actions as intended by the user. Thus, there is a need to improve the interactive experience of users with bad eye-sight.

In simple forms, hand gestures of the user are a primary mode of interaction in the HMD. The main form of a feedback to the user from the HMD is through a display. For users with the eye power, prescription lens inserts (or Rx inserts) are advised. When the users with the eye power do not use these Rx inserts, it will result in an uncomfortable experience for the users. In such cases, the users will not be able to select and navigate efficiently. Further, there are various issues that could arise from the use of Rx inserts. The users' eye power also might not remain the same over a period of time. While sharing the device among multiple users, applying the Rx inserts is a hassle. The seamless user interaction just by providing eye power to the HMD is needed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and an electronic device for managing hand interaction of a user in a XR environment created by the electronic device.

Another aspect of the disclosure is to handle a diffusion region estimation for hand ray in the XR environment.

Another aspect of the disclosure is to generate one or more perceived hand images of a user by correlating the input hand images of the electronic device, and an eye power prescription of the user, where the generated hand images represents user's visual perception of the input hand images.

Another aspect of the disclosure is to estimate a region of ambiguity for each keypoint of user's hand by performing hand tracking of user's hand using the generated hand images representing the user's visual perception of the input hand images.

Another aspect of the disclosure is to enhance the hand interactions of the user in the XR environment using the electronic device.

Another aspect of the disclosure is to estimate the effective eye power of the user after detecting the presence of in Rx inserts and the amount of defect in the Rx inserts.

Another aspect of the disclosure is to naturalize the input image such that the electronic device also sees the hand images similar to how the user would perceive them without the eye power correction.

Another aspect of the disclosure is to diffuse User Interface (UI) elements as well as a virtual selection pointer region and estimate an overlap region resulting in selection interaction with the UI elements.

Another aspect of the disclosure is to interact with the electronic device assuming that the user is able to see the display perfectly.

Another aspect of the disclosure is to customize the interaction experience to the user based on the user's eye power and Rx inserts used.

Additional aspects will be set forth in part in the description which follows and, in part, will be apparent from the description, or may be learned by practice of the presented embodiments.

### SUMMARY

In accordance with an aspect of the disclosure, a method performed by an electronic device may be provided. The method may include comparing original hand data and perceived hand data to identify at least one uncertain input zone in a screen of the electronic device, The method may include identifying a pointer indicating a finger of a user pointing towards at least one of a first user interface (UI) element, or a second UI element in the at least one identified uncertain input zone. The method may include modifying a size of the pointer based on a size of the at least one identified uncertain input zone. The method may include determining an extent of an overlap of the pointer with at least one of the first UI element, or the second UI element. The method may include selecting and activating at least one of the first UI element, or the second UI element that has a maximum overlap with the pointer.

In accordance with another aspect of the disclosure, an electronic device may be provided. The electronic device may include memory storing at least one instruction, and at least one processor operatively coupled with the memory and comprising processing circuitry. The at least one instruction, when executed by the at least one processor individually or collectively, causes the electronic device to compare original hand data and perceived hand data to identify at least one uncertain input zone in a screen of the electronic device. The at least one instruction, when executed by the at least one processor individually or collectively, causes the electronic device to identify a pointer indicating a finger of a user pointing towards at least one of a first UI element, or a second UI element in the at least one identified uncertain input zone. The at least one instruction, when executed by the at least one processor individually or collectively, causes the electronic device to modify a size of the pointer based on a size of the at least one identified uncertain input zone. The at least one instruction, when executed by the at least one processor individually or collectively, causes the electronic device to determine an extent of an overlap of the pointer with at least one of the first UI element, or the second UI element. The at least one instruction, when executed by the at least one processor individually or collectively, causes the electronic device to select and activate at least one of the first UI element, or the second UI element that has a maximum overlap with the pointer.

In accordance with another aspect of the disclosure, one or more non-transitory computer-readable storage media storing one or more computer programs including computer-executable instruction that, when executed by one or more processors of an electronic device individually or collectively, cause the electronic device to perform the method.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIGS. 1A, 1B, 1C, and 1D illustrate Rx inserts being used in various electronic devices from various service providers, according to an embodiment of the disclosure;

FIG. 2 illustrates an overall block diagram of an electronic device for managing hand interaction of a user within an environment, according to an embodiment of the disclosure;

FIG. 3 is a flowchart depicting a method for managing hand interaction with an electronic device, according to an embodiment of the disclosure;

FIG. 4 is a flowchart depicting a process for estimating a perception kernel in order to generate at least one perceived hand image for a defective Rx insert, while managing the hand interaction with the electronic device, according to an embodiment of the disclosure;

FIG. 5 is a flowchart depicting a process for estimating a perception kernel in order to generate at least one perceived hand image, when RX insert is not detected, according to an embodiment of the disclosure;

FIG. 6 is a flowchart depicting a method for obtaining a dynamic diffused region in hand ray using the electronic device, according to an embodiment of the disclosure;

FIG. 7 illustrate a simplified flow diagram of a process, for estimating diffusion region for hand ray with the electronic device, according to an embodiment of the disclosure;

FIG. 8 is a schematic presentation of a dynamic diffused region around a virtual selection pointer, wherein a plurality of UI elements are displayed in a screen of an electronic device, according to an embodiment of the disclosure;

FIG. 9 is a flow diagram depicting a method of selecting an UI element by a hand interaction with the electronic device through estimation of a static diffused region and a dynamic diffused region, according to an embodiment of the disclosure;

FIG. 10 is a flow diagram depicting a process for determining Rx insert power for blur kernel estimation, when a user is using an electronic device associated with a defective Rx insert, according to an embodiment of the disclosure;

FIG. 11 is a process block diagram depicting estimation of an Rx insert defect in an electronic device, for obtaining a blur kernel, according to an embodiment of the disclosure;

FIG. 12 is a flow diagram depicting a process for obtaining blur kernel for generating a perceived hand image of user having eye power, in absence of Rx inserts in an electronic device, according to an embodiment of the disclosure;

FIGS. 13A, 13B, 13C, and 13D are depicting schematic diagrams of Rx insert detection, according to an embodiment of the disclosure;

FIG. 14 depicts a simplified flow diagram of a process of offline calibration for estimation of blur kernel, according to an embodiment of the disclosure;

FIGS. 15A, 15B, and 15C illustrate processes for a naturalized image generation and region of ambiguity detection, according to an embodiment of the disclosure;

FIG. 16 depicts a process detection of a dynamic diffused region for a virtual selection pointer, according to an embodiment of the disclosure;

FIG. 17 is a schematic diagram depicting more enlarged dynamic diffused region as a perceived hand image becomes more blurred, according to an embodiment of the disclosure;

FIG. 18 depicts a process for modifying a virtual selection pointer in a screen to match a region of ambiguity around hand key point, according to an embodiment of the disclosure;

FIG. 19 illustrates a schematic diagram of static diffused region detection on UI elements and a diffused region overlap estimation, according to an embodiment of the disclosure; and

FIG. 20 depicts a comparison of different user of an electronic device experiencing hand interaction with the electronic device, according to an embodiment of the disclosure.

Throughout the drawings, like reference numerals will be understood to refer to like parts, components, and structures. It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration. Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of an embodiment of the disclosure. Furthermore, in terms of the construction of the device, one or more components of the device may have been represented in the drawings by symbols of the related art, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by symbols of the related art, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words, such as first, second, third or the like, to describe components/elements/steps is for the purposes of this description and should not be construed as sequential ordering/placement/occurrence unless specified otherwise.

The embodiments herein achieve a method for managing hand interaction of a user on a screen of an electronic device. The method may include comparing, by the electronic device, an original hand data and a perceived hand data to identify at least one uncertain input zone in the screen of the electronic device. Further, the method may include identifying, by the electronic device, a pointer. The pointer may be representative of a finger of the user pointing towards at least one of: a first user interface (UI) element, and a second UI element in the at least one identified uncertain input zone in the screen. Further, the method may include modifying, by the electronic device, a size of the pointer based on a size of the at least one identified uncertain input zone. Further, the method may include determining, by the electronic device, an extent of an overlap of the modified pointer with at least one of: the first UI element, and the second UI element. Further, the method may include selecting and activating, by the electronic device, at least one of: the first UI element, and the second UI element that has a maximum overlap with the modified pointer.

Based on the proposed method, users no longer have to assume perfect vision. Even when the Rx inserts are defective, they will still experience seamless interaction with the HMD. The proposed method customizes the interaction experience based on the user's eye prescription and the specific Rx insert being used. It enables at least a 5× improvement (for example) in the user experience for individuals with vision impairments.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

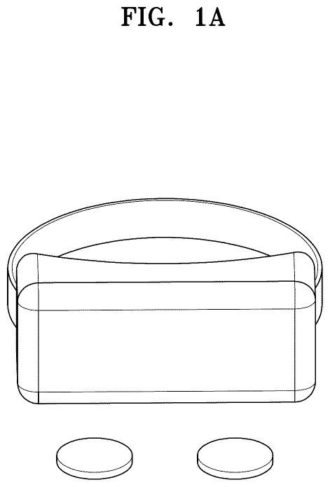

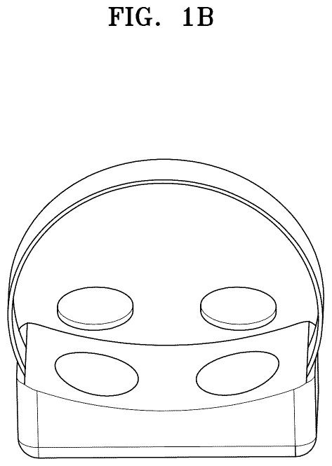

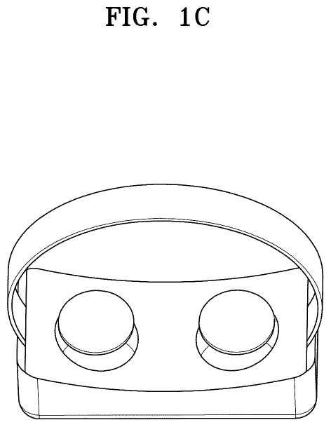

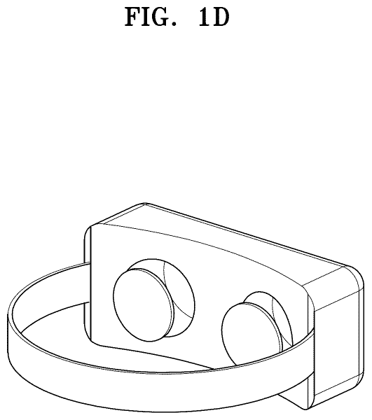

Referring now to the drawings, and more particularly to FIGS. 1A, 1B, 1C, 1D, 2 to 12, 13A, 13B, 13C, 13D, 14, 15A, 15B, 15C, and 16 to 20, where similar reference characters denote corresponding features consistently throughout the figures, there are shown embodiments.

FIGS. 1A, 1B, 1C, and 1D illustrate Rx inserts being used in various electronic devices from various service providers, according to an embodiment of the disclosure. In an example, Rx inserts are used in various HMDs from various service providers as shown in FIGS. 1A to 1D.

FIG. 1A is a front view of an electronic device and Rx inserts placed in front of the electronic device according to an embodiment of the disclosure. FIGS. 1B, 1C, and 1D are back views of an electronic device showing where Rx inserts go in the electronic device according to an embodiment of the disclosure.

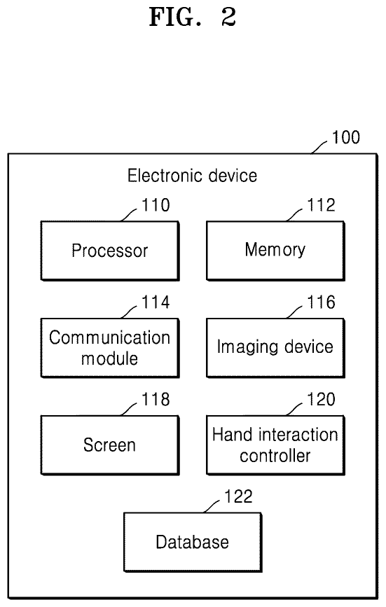

FIG. 2 illustrates an overall block diagram of an electronic device for managing hand interaction of a user within an environment (e.g., virtual reality (VR) environment, XR environment or the like), according to an embodiment of the disclosure.

Referring to FIG. 2, according to an embodiment of the disclosure, the electronic device 100 may comprise, a processor 110, memory 112, a communication module 114, an imaging device (e.g., eye tracker, camera or the like) 116, a screen 118, a hand interaction controller 120 and a database 122. The processor 110 may be coupled with the memory 112, the communication module 114, the imaging device 116, the screen 118, the hand interaction controller 120 and the database 122. In an example, the electronic device 100 can be any of a head-mounted display (HMD) device, a virtual reality (VR) headset, an augmented reality (AR) headset, a smart goggle, a safety eyewear, an extended reality (XR) device, a Video See-Through (VST) device, and so on. In an example herein, use cases of the electronic device 100 can include VR gaming or training applications, AR smart glasses for enterprise or medical use, military or industrial safety goggles with integrated displays, consumer headsets for vision-corrected users and so on.

The hand interaction controller 120 may compare an original hand data and a perceived hand data to identify an uncertain input zone in the screen 118 of the electronic device 100. According to an embodiment of the disclosure, the hand interaction controller 120 captures the original hand data indicating an original hand position of the user. Further, the hand interaction controller 120 may generate the perceived hand data indicating a perceived hand position of the user. The hand interaction controller 120 may compare the original hand data, and the perceived hand data to identify the at least one uncertain input zone. According to an embodiment of the disclosure, the original hand data indicating the original hand position of the user, and the perceived hand data indicating the perceived hand position of the user may be estimated based on a perception kernel.

According to an embodiment of the disclosure, the perception kernel may be estimated by obtaining an eye power input indicating an eye power of the user, obtaining at least one eye input image from the imaging device 116, determining that an insert is detected using the at least one eye input image and the eye power of the user, determining a defect in the detected insert, computing an insert power using an original eye power and the determined defect in the detected insert and computing a blur kernel for the perception using the user eye power and the computed insert power.

According to an embodiment of the disclosure, the perception kernel may be estimated by obtaining the eye power input indicating an eye power corresponding to the user, obtaining at least one eye input image from the imaging device 116, determining whether the insert is detected using the at least one eye input image and the eye power of the user, determining that the insert power as zero upon determining that the insert is not detected, and computing the blur kernel for the perception using the user eye power based on the determination.

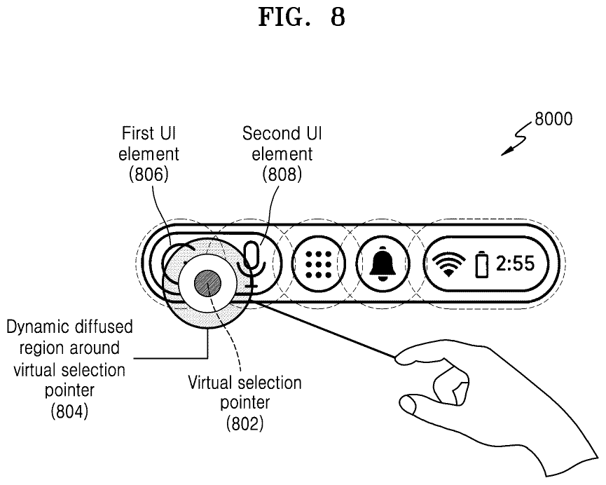

According to an embodiment of the disclosure, the perceived hand position of the user may be determined based on a perceived eye power due to the defect in the insert placed in the electronic device 100. The perceived eye power may be determined by obtaining an input comprising a UI element selection history of the user, computing an average distance of a virtual selection pointer 802 (as shown in FIG. 8) from a center of the UI element, from the UI element selection history, during selection, computing an average number of pinches required by the user to select the UI element from the history of UI element selection history, and determining the user perceived eye power from a weighted sum of the computed average distance and the computed average number of pinches.

Further, the hand interaction controller 120 may identify a pointer representative of a finger of the user pointing towards a first UI element 806 (as shown in FIG. 8) and a second UI element 808 in the identified uncertain input zone in the screen 118. The first UI element 806 and the second UI element 808 may be adjacent to each other in the at least one uncertain input zone.

Further, the hand interaction controller 120 may modify a size of the pointer based on a size of the identified uncertain input zone. According to an embodiment of the disclosure, the hand interaction controller 120 may estimate hand key point and a virtual selection pointer 802 from a blurred image. Further, the hand interaction controller 120 may use the estimated hand key point and the virtual selection pointer 802 to guide estimation in at least one subsequent iteration process. The at least one subsequent iteration process may enable a user to model a degradation perceived by the user, where an area of the at least one identified uncertain input zone increases as the image gets more blurred. Further, the hand interaction controller 120 may modify the pointer to the size that substantially matches with the size of the at least one identified uncertain input zone based on the estimation.

Further, the hand interaction controller 120 may determine an extent of an overlap of the modified pointer with at least one of: the first UI element 806 and the second UI element 808. Further, the hand interaction controller 120 may select and activates at least one of: the first UI element 806 and the second UI element 808 that has a maximum overlap with the modified pointer.

According to an embodiment of the disclosure, the hand interaction controller 120 may obtain the first image associated with the hand captured by the electronic device 100 and the eye power prescription of the user. According to an embodiment of the disclosure, the at least one first image associated with the hand captured by the electronic device 100 and the eye power prescription of the user may be obtained in response to an initiation of at least one hand interaction of the user with at least one UI element rendered by the electronic device 100. The at least one hand interaction may be initiated using the virtual selection pointer 802.

Further, the hand interaction controller 120 may generate the second image of the hand by correlating the first image and the eye power prescription, where the second image of hand represents the visual perception of the first images of the hand. The at least one second image of hand may represent the visual perception of the at least one first image of the hand. Further, the hand interaction controller 120 may estimate the region of ambiguity for each key point of the hand by performing hand tracking of user's hand using the generated second image.

Further, the hand interaction controller 120 may modify the region of the virtual selection pointer 802 based on the estimated region of ambiguity. Further, the hand interaction controller 120 may perform the hand interaction with the at least one UI element based on an extent of overlap between the modified region of the virtual selection pointer 802 and a region of selection associated with the at least one UI element.

According to an embodiment of the disclosure, the processor 110 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The processor 110 may include multiple cores and is configured to execute the instructions stored in the memory 112.

Further, the processor 110 may be configured to execute instructions stored in the memory 112 and to perform various processes. The communication module 114 may be configured for communicating internally between internal hardware components of the electronic device 100 and with external devices via one or more networks. The memory 112 also may store instructions to be executed by the processor 110. The memory 666 may store at least one instruction. The memory 112 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 112 may, in some examples, be considered a non-transitory storage medium. The term “non-transitory” may indicate that the storage medium is not embodied in a carrier wave or a propagated signal. However, the term “non-transitory” should not be interpreted that the memory 112 is non-movable. In certain examples, a non-transitory storage medium may store data that can, over time, change (e.g., in random access memory (RAM) or cache).

The processor 110 may write data to the memory 112 or read data stored in the memory 112. In particular, the processor 110 may process data according to defined operation rules or an artificial intelligence (AI) model by executing a program or at least one instruction stored in the memory 112. Accordingly, the processor 110 may perform operations described in the following embodiments, and unless otherwise specified, operations described as being performed by the electronic device 100 or by components included in the electronic device 100 may be understood as being performed by the processor 110.

At least one processor included in the processor 110 may include processing circuitry. The at least one processor included in the processor 110 may execute instructions stored in the memory 112, individually or collectively.

The memory 112 may be a component configured to store various programs or data, and may include a storage medium such as a read-only memory (ROM), random access memory (RAM), hard disk, CD-ROM, DVD, or a combination of such storage media. The memory 112 may not be implemented as a separate component but may be integrated into the processor 110. The memory 112 may include volatile memory, non-volatile memory, or a combination of volatile and non-volatile memory. A program or at least one instruction for performing operations according to the embodiments described below may be stored in the memory 112. The memory 112 may also provide the stored data to the processor 110 in response to a request from the processor 110.

According to an embodiment of the disclosure, the communication module 114 may include an electronic circuit specific to a standard that enables wired or wireless communication. The communication module 114 may be configured to communicate internally between internal hardware components of the electronic device 100 and with external devices via one or more networks.

According to an embodiment of the disclosure, the imaging device 116 may be a camera unit in the electronic device 100, wherein the imaging device 116 can capture one or more first images of eyes of a user of the electronic device 100, wherein the one or more first images can provide eye movement of the user. According to an embodiment of the disclosure, the imaging device 116 may detect presence of Rx inserts for eyes in order to address a defective vision of the user looking at the screen 118. According to an embodiment of the disclosure, the screen 118 may refer to a display within the electronic device 100, and providing VR environment to the user.

According to an embodiment of the disclosure, the database 122 may store the one or more first images, the one or more second images, and an input to estimate a blur kernel for generating the one or more perceived hand images, an output of the blur kernel, and User context and UI elements selection history.

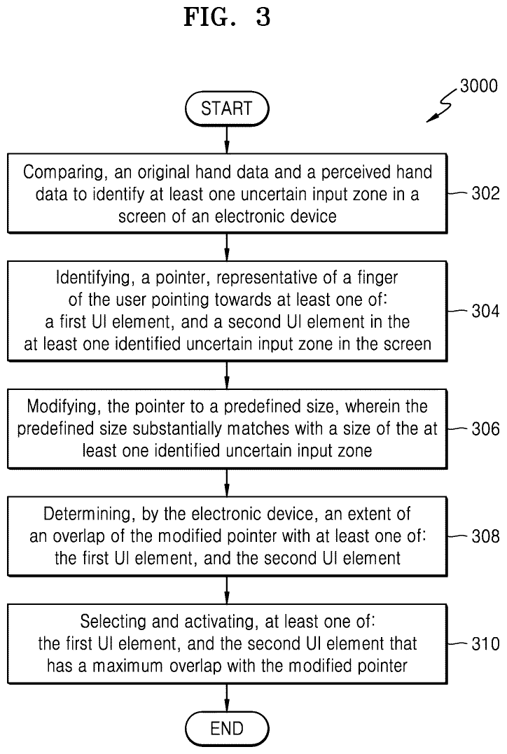

FIG. 3 is a flowchart 3000 depicting a method for managing hand interaction with an electronic device, according to an embodiment of the disclosure. The operations 302-310 may be handled by the hand interaction controller 120.

Referring to FIG. 3, at operation 302, the method may comprise comparing the at least one original hand data and the at least one perceived hand data to identify the at least one uncertain input zone on the screen 118 of the electronic device 100. According to an embodiment of the disclosure, the electronic device 100 may capture the original hand data indicating the original hand position of the user. Further, the electronic device 100 may generate the at least one perceived hand data indicating the perceived hand position of the user. Thereby, the electronic device 100 may compare the original hand data and the perceived hand data to identify the at least one uncertain input zone. According to an embodiment of the disclosure, the perceived hand position of the user may be determined based on at least one of: the perceived eye power due to the defect in Rx inserts placed in the electronic device 100, and the perceived eye power when the Rx inserts are absent. According to an embodiment of the disclosure, the perceived eye power may be determined by the electronic device 100 from the obtained input from the database 122, wherein the obtained input may comprise the UI element selection history of the user and the computed average distance of the virtual selection pointer 802 from the center of the UI element, from the UI element selection history, during selection. To determine the perceived eye power, the electronic device 100 may compute the average number of pinches required by the user to select the UI element from the history of UI element selection history and determines a weighted sum of the computed average distance and the computed average number of pinches.

At operation 304, the method may comprise, identifying the pointer, wherein the pointer may be representative of the finger of the user pointing towards at least one of: the first UI element 806, and the second UI element 808 in the at least one identified uncertain input zone in the screen 118.

At operation 306, the method may comprise modifying the pointer to the size, wherein the size may substantially match with the size of the at least one identified uncertain input zone. According to an embodiment of the disclosure, the electronic device 100 may modify the virtual selection pointer 802 through generating a dynamic diffused region 804 (as shown in FIG. 8) from a plurality of hand key-point confidence distribution and hand key-point positions.

At operation 308, the method may comprise determining the extent of the overlap of the modified pointer with at least one of: the first UI element 806, and the second UI element 808. According to an embodiment of the disclosure, the first UI element 806 and the second UI element 808 may be adjacent to each other in the at least one uncertain input zone.

At operation 310, the method may comprise selecting and activating at least one of: the first UI element 806, and the second UI element 808 that has the maximum overlap with the modified pointer. According to an embodiment of the disclosure, the original hand data indicating the original hand position of the user, and the perceived hand data indicating the perceived hand position of the user may be estimated based on the perception kernel.

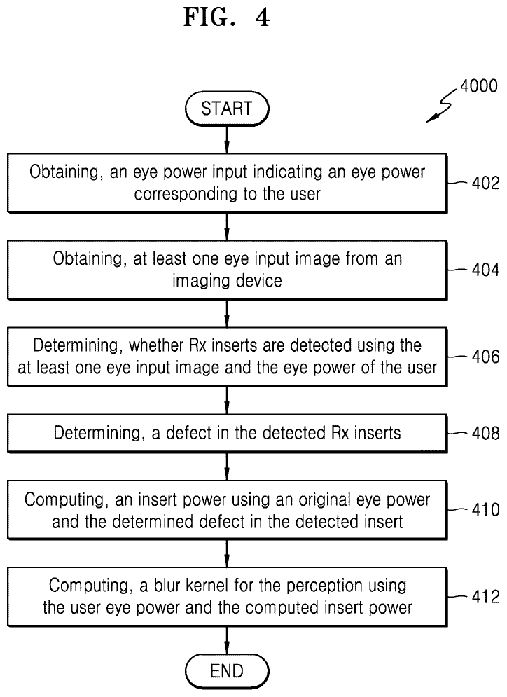

FIG. 4 is a flowchart 4000 depicting a process for estimating a perception kernel in order to generate at least one perceived hand image for a defective Rx insert according to an embodiment of the disclosure. The operations 402-412 may be handled by the hand interaction controller 120.

Referring to FIG. 4, at operation 402, the method may comprise obtaining the eye power input indicating the eye power corresponding to the user. At operation 404, the method may comprise obtaining the at least one eye input image from the imaging device 116. At operation 406, the method may comprise determining whether inserts are detected using the at least one eye input image and the eye power of the user.

At operation 408, the method may comprise determining the defect in the Rx inserts. At operation 410, the method may comprise computing the insert power using the original eye power and the determined defect in the detected insert. At operation 412, the method may comprise computing the blur kernel for the perception using the user eye power and the computed insert power.

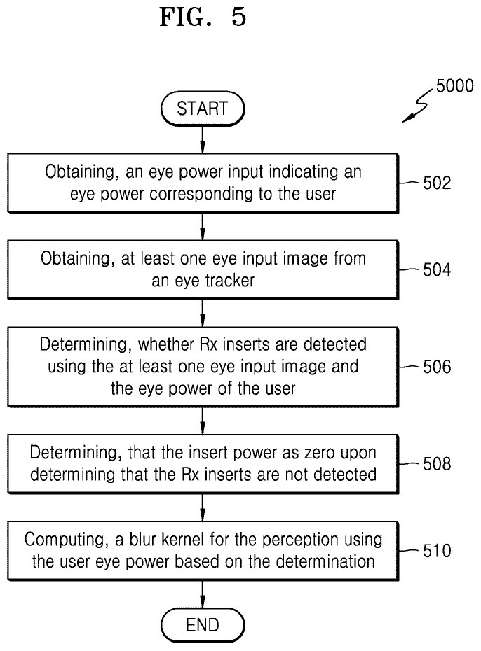

FIG. 5 is a flowchart 5000 depicting a process for estimating a perception kernel in order to generate at least one perceived hand image, when RX insert is not detected according to an embodiment of the disclosure. The operations 502-510 may be handled by the hand interaction controller 120.

Referring to FIG. 5, at operation 502, the method may comprise obtaining the eye power input indicating the eye power corresponding to the user. At operation 504, the method may comprise obtaining the at least one eye input image from the imaging device 116. At operation 506, the method may comprise determining whether Rx inserts are detected using the at least one eye input image and the eye power of the user.

At operation 508, the method may comprise determining that the insert power as zero upon determining that the Rx inserts are not detected. At operation 510, the method may comprise computing the blur kernel for the perception using the user eye power based on the determination.

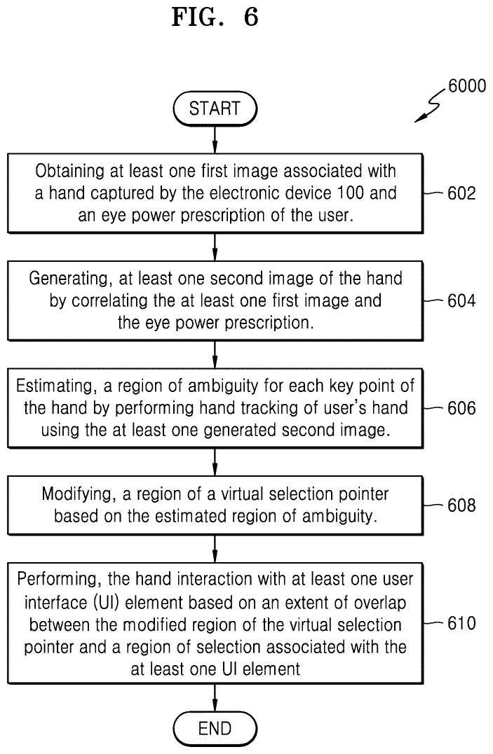

FIG. 6 is a flowchart 6000 depicting a method for obtaining a dynamic diffused region 804 in hand ray using an electronic device according to an embodiment of the disclosure. The operations 602-610 may be handled by the hand interaction controller 120.

Referring to FIG. 6, at operation 602, the method may comprise obtaining the at least one first image associated with the hand captured by the electronic device 100 and the eye power prescription of the user. According to an embodiment of the disclosure, the at least one hand interaction may be initiated using the virtual selection pointer 802, wherein the at least one second image (perceived hand image) of hand may represent the visual perception of the at least one first image of the hand.

At operation 604, the method may comprise generating the at least one second image of the hand by correlating the at least one first image and the eye power prescription. According to an embodiment of the disclosure, the at least one first image associated with the hand captured by the electronic device 100 and the eye power prescription of the user may be obtained in response to the initiation of the at least one hand interaction of the user with the at least one UI element rendered by the electronic device 100.

At operation 606, the method may comprise estimating the region of ambiguity for each key point of the hand by performing hand tracking of user's hand using the at least one generated second image.

At operation 608, the method may comprise modifying the region of the virtual selection pointer 802 based on the estimated region of ambiguity.

At operation 610, the method may comprise performing the hand interaction with the at least one user interface (UI) element based on the extent of overlap between the modified region of the virtual selection pointer 802 and the region of selection associated with the at least one UI element.

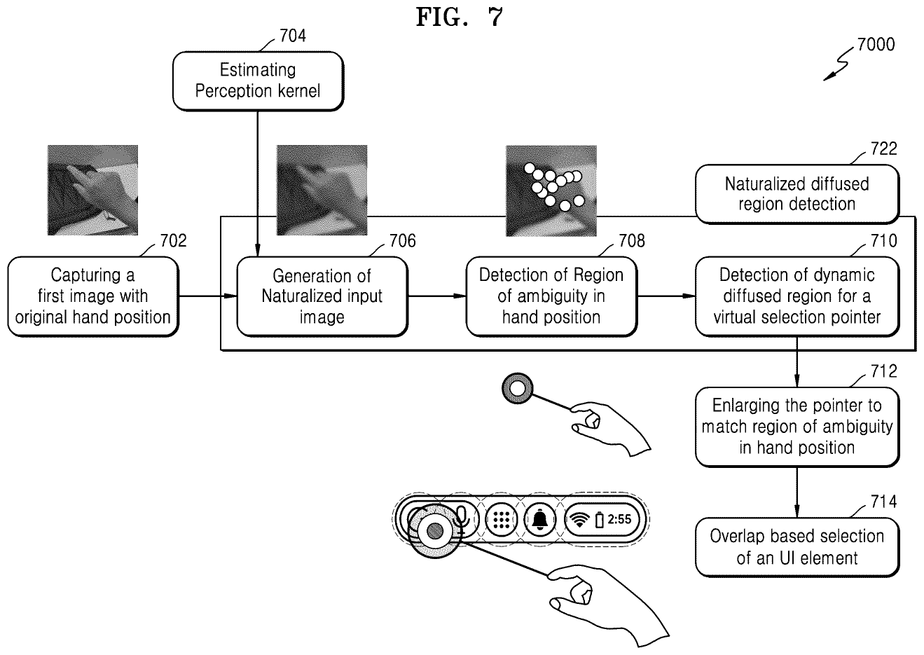

FIG. 7 illustrates a simplified flow diagram 7000 representing a process for estimating a diffusion region for a hand ray by using an electronic device according to an embodiment of the disclosure.

Referring to FIG. 7, at block 702, the process may include capturing, by the electronic device 100, one or more first images of hand, wherein the one or more first images may include the original hand position of the user.

At block 704, the process may include estimating the perception kernel (or a blur kernel) for the user from eye power. According to an embodiment of the disclosure, the electronic device 100 may detect the Rx inserts associated with the electronic device 100, wherein an Rx insert power may be used to estimate the perception kernel. According to an embodiment of the disclosure, the Rx inserts may be one of: a defective Rx inserts and a non-defective Rx inserts, wherein the defective Rx inserts may be detected by the electronic device 100. Further, according to an embodiment of the disclosure, the perception kernel may be estimated for the user using the electronic device 100 without an Rx insert.

At block 722, the process may include detecting, by the electronic device 100, at least one naturalized diffused region. At block 706, the method may include generating, by the electronic device 100, the one or more naturalized input images from the one or more first images and the perception kernel. According to an embodiment of the disclosure, the one or more naturalized input images may include one or more perceived hand image of the user, wherein the one or more perceived hand images may correspond to user's visual perception of the one or more first images.

At block 708, the method may include detecting, by the electronic device 100, one or more regions of ambiguity in hand position of the user, for each perceived hand image. At block 710, the method may include detecting, by the electronic device 100, the dynamic diffused region 804 of the virtual selection pointer 802, wherein the virtual selection pointer 802 may be pointing towards one or more UI elements appearing on the screen 118.

At block 712, the process may include modifying, by the electronic device 100, the pointer to the size which matches the region of ambiguity. According to an embodiment of the disclosure, the electronic device 100 may enlarge the dynamic diffused region 804 of the virtual selection pointer 802 to substantially match the dynamic diffused region 804 with the region of ambiguity. At block 714, the process may include selecting, by the electronic device 100, the UI element between at least two UI elements that are adjacent to each other, where the UI element may be selected based on the extent of overlap of the enlarged virtual selection pointer 802 with the at least two UI elements.

FIG. 8 is a schematic presentation 8000 of a dynamic diffused region 804 around a virtual selection pointer 802, wherein a plurality of UI elements 806, 808 are displayed on a screen 118 according to an embodiment of the disclosure.

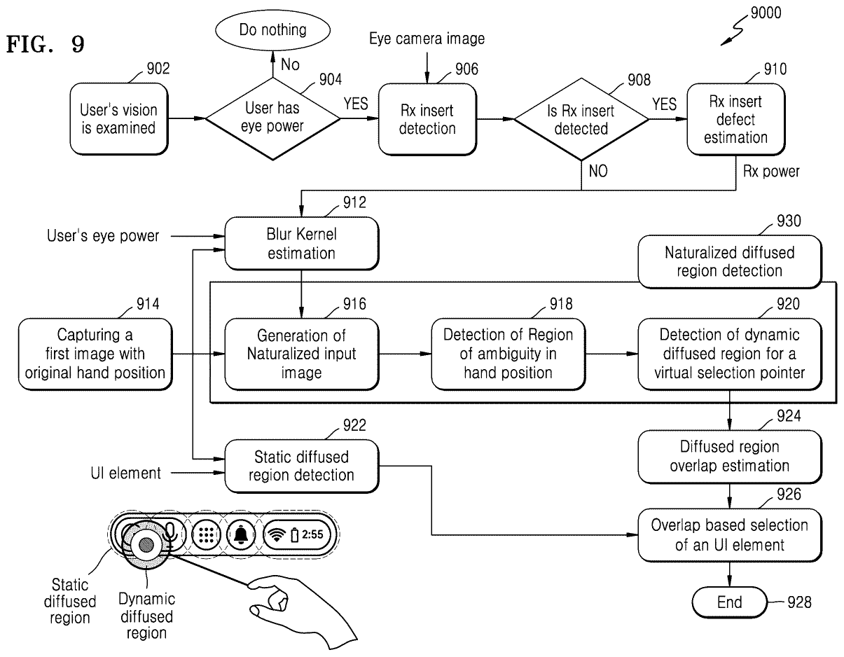

FIG. 9 is a flow diagram 9000 depicting a method of selecting the UI element by a hand interaction with an electronic device through estimation of a static diffused region and a dynamic diffused region, according to an embodiment of the disclosure.

Referring to FIGS. 8 and 9, at block 902, the vision of the user may be examined and any refractive error associated with user's vision is detected, by the electronic device 100. According to an embodiment of the disclosure, the electronic device 100 may receive the eye power prescription of the user. Further, according to an embodiment of the disclosure, the electronic device 100 may derive any refractive error associated with the user's vision through vision assessment techniques.

At block 904, the electronic device 100 may evaluate if the user has an eye power, i.e., any refractive error associated with user's vision. At block 906, the electronic device 100 may detect presence of Rx inserts, when the user has eye power. Followed by block 908, wherein the electronic device 100 may evaluate if the Rx inserts are present. According to an embodiment of the disclosure, the Rx inserts may be detected from images of the imaging device 116.

At block 910, the electronic device 100 may estimate the defect in the Rx inserts. According to an embodiment of the disclosure, the defect in Rx inserts may be estimated from user context, wherein the user context may include an intent of user to select an UI element displayed in the screen 118 through hand interaction, using the electronic device 100, wherein the user has eye power.

At block 912, the blur kernel may be estimated from user's eye power and the Rx power of Rx inserts, in order to estimate effect of blurring in visuals displayed to the user having eye power.

At block 914, the electronic device 100 may capture one or more first images including original hand position of the user having the eye power. The imaging device 116 may track eye movement of the user.

At block 916, one or more second images of naturalized input image may be generated by the electronic device 100, from the one or more first images and the perception kernel. According to an embodiment of the disclosure, the one or more second images may include one or more perceived hand image representing user's visual perception of the first image of user's hand. According to an embodiment of the disclosure, the one or more second images may be generated by progressively applying blur to the one or more first images, wherein the blur may be obtained from the blur kernel estimation.

At block 918, the electronic device 100 may estimate and detect from the one or more generated naturalized input images, one or more regions of ambiguity in hand position of the user. According to an embodiment of the disclosure, the region of ambiguity may be estimated for each keypoint of user's hand, by performing hand tracking using a hand interaction controller 120. The region of ambiguity in the hand position of the user may be estimated based on the blur applied to the one or more perceived hand images.

At block 920, the electronic device 100 may detect the dynamic diffused region 804 of the virtual selection pointer 802 by hand tracking, when the virtual selection pointer 802 may be identified in the one or more regions of ambiguity. According to an embodiment of the disclosure, the electronic device 100 may modify the size of the identified virtual selection pointer 802 in order to obtain the dynamic diffused region 804 which substantially match with the size of a region of ambiguity.

At block 922, the electronic device 100 may detect the static diffused region around each UI element displayed on the screen 118. The static diffused region may be a region of selection to the virtual selection pointer 802 around the UI element.

At block 924, the electronic device 100 may estimate extent of overlapping between the modified virtual selection pointer 802 and the region of selection around the UI element. At block 926, the electronic device 100 may select the UI element based on detection of extent of overlap of the dynamic diffused region 804 of the virtual selection pointer 802 and the static diffused region and ends the operation at block 928.

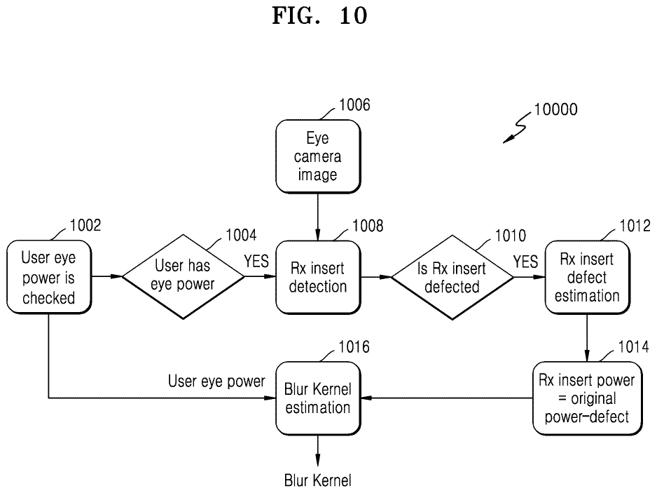

FIG. 10 is a flow diagram 10000 of a process for determining Rx insert power for a blur kernel estimation, when a user is using an electronic device associated with a defective Rx insert, according to an embodiment of the disclosure.

Referring to FIG. 10, at operation 1002, the eye power of user may be determined by the electronic device 100. Further, according to an embodiment of the disclosure, the electronic device 100 may receive the eye power prescription of the user. At operation 1004, the electronic device 100 may evaluate that the user has eye power for, such as, refractive error in eye and so on.

At operation 1006, the electronic device 100 may capture the one or more eye images of the user. At operation 1008, the electronic device 100 may detect presence of Rx inserts in the electronic device 100, from the user eye power and the one or more eye images of the user. In an example, a Multi-Layer Perception (MLP) module is trained to output the presence of Rx inserts using an eye tracking camera images as input.

At operation 1010, the electronic device 100 may evaluates if the Rx inserts placed between the eye and the screen 118 is defected Rx inserts. At operation 1012, the electronic device 100 may estimate the defect in the Rx insert, wherein the defect may be estimated using the user context and the UI element selection history. According to an embodiment of the disclosure, the user context may include user intent comprising what the user wants to select based on the recent history of user interactions.

At operation 1014, the electronic device 100 may determine the Rx insert power for estimation of the blur kernel in order to manage hand interaction. The Rx insert power may be obtained by subtracting the estimated Rx insert defect from the original eye power of the user. At operation 1016, the electronic device 100 may estimate the blur kernel from the user eye power and the determined Rx insert power.

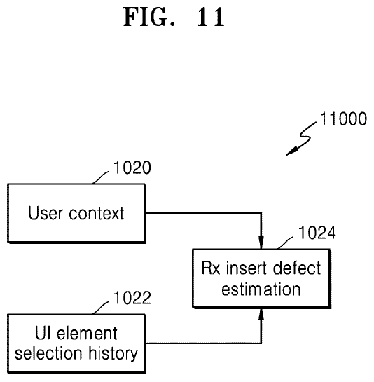

FIG. 11 is a process block diagram 11000 depicting estimation of Rx insert defect in an electronic device for obtaining a blur kernel according to an embodiment of the disclosure.

Referring to FIG. 11, at block 1020, the user context in the VR may be detected by the hand interaction controller 120. The user context may estimate what the user wants to select based on the recent history of user interactions. According to an embodiment of the disclosure, the user context may include such as one or more detected UI elements the user intents to select and user hand interaction with the one or more UI elements.

At block 1022, UI element selection history may be obtained by the hand interaction controller 120. According to an embodiment of the disclosure, the UI element selection history may comprise average distance of the virtual selection pointer 802 from center of the UI element during selections and average number of pinches required by the user to select the UI element, wherein the user may be trying to select the UI element based on the user context.

At block 1024, the hand interaction controller 120 may estimate RX insert defect, from the detected user context and the obtained UI element selection history. The average distance of the virtual selection pointer 802 from the center of the UI element during selections may be directly proportional to the Rx insert defects, i.e., Rx defect∝avg distance (D). The average number of pinches required by the user to select the user experience (UX) element may be directly proportional to the Rx insert defects, i.e., Rx defect∝avg num of pinches (N). The Rx insert defect may be estimated as, Rx defect=aD+(N−1), where a and b are proportionality constants. The detected Rx defect may be the perceived eye power of the user.

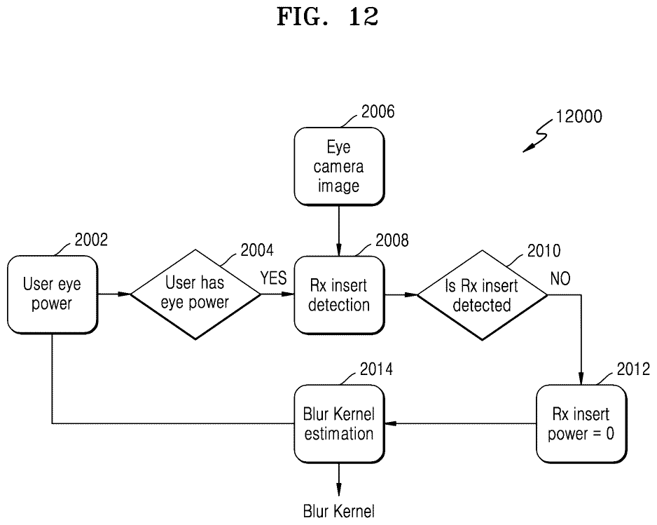

FIG. 12 is a flow diagram 12000 of a process for obtaining a blur kernel for generating a perceived hand image of a user having eye power, in absence of Rx inserts in an electronic device, according to an embodiment of the disclosure.

Referring to FIG. 12, at operation 2002, the eye power of user may be checked (or determined) by the electronic device 100. Further, according to an embodiment of the disclosure, the electronic device 100 may receive the eye power prescription of the user. At operation 2004, the electronic device 100 may evaluate that the user has eye power for defective eyes, such as, refractive error in eyes and so on.

At operation 2006, the electronic device 100 may capture the one or more eye images of the user. According to an embodiment of the disclosure, the imaging device 116 of the electronic device 100 may track movement of eyes of the user having eye power.

At operation 2008, the electronic device 100 may detect if the Rx inserts are present in the electronic device 100, using the user eye power and the one or more eye images of the user. In an example, the MLP module may be trained to output the presence of Rx inserts using the eye tracking camera images as input, wherein the MLP may output an information that the RX insert is not present.

At operation 2010, the electronic device 100 may evaluate whether the Rx inserts are present between the eyes of the user and the screen 118 and determine that the Rx inserts are not present. At operation 2012, the electronic device 100 may determine the Rx insert power for estimation of a blur kernel in order to manage hand interaction. The Rx insert power may be set at “0”. At operation 2014, the electronic device 100 may estimate a blur kernel from user eye power and the determined Rx insert power.

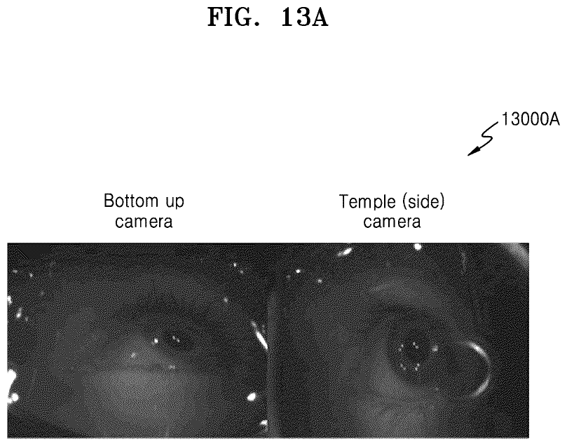

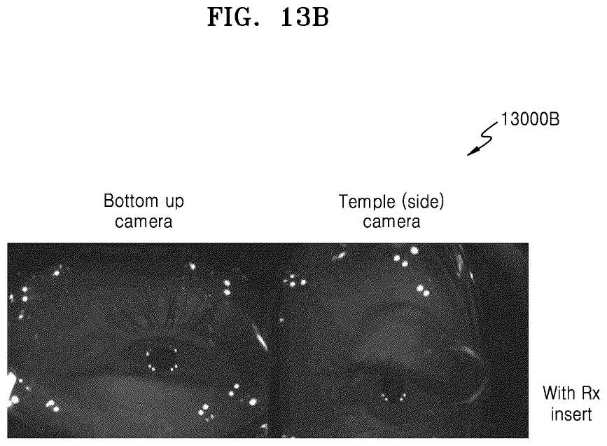

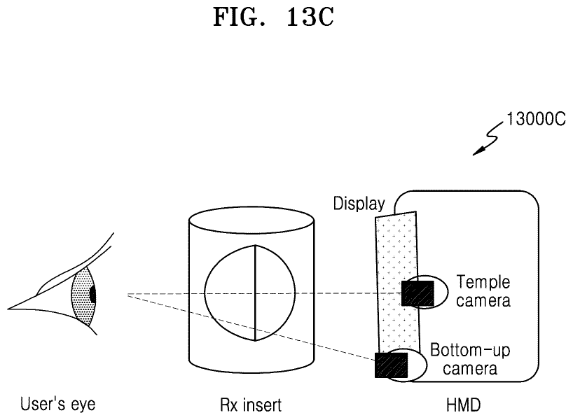

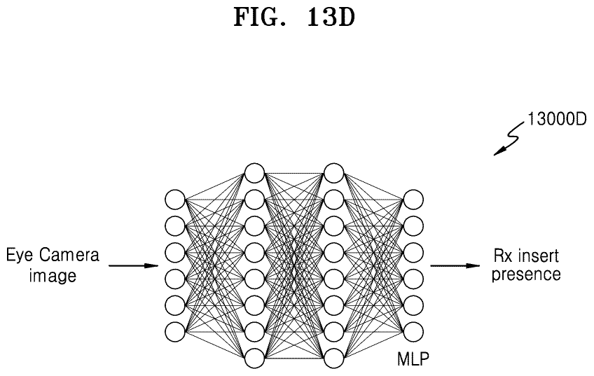

FIGS. 13A, 13B, 13C, and 13D depicts schematic diagrams 13000 (including 13000A, 13000B, 13000C, and 13000D) of Rx insert detection, according to an embodiment of the disclosure.

Referring to FIG. 13A, it shows images from eye camera when the Rx inserts are absent.

FIG. 13B illustrates images from eye camera when Rx inserts are present.

FIG. 13C illustrates a hardware setup of Rx inserts between eyes and an HMD.

FIG. 13D illustrates a pipeline for Rx insert detection using images from an eye camera. According to an embodiment of the disclosure, one or more imaging device 116 (or, eye tracking cameras) may be used to capture eye movement of the user. The one or more eye trackers may be, such as, a bottom-up camera for capturing eye image, a temple side camera for capturing eye image. The figures may depict eye images as captured by the one or more eye trackers with Rx inserts presence and without Rx inserts. According to an embodiment of the disclosure, the Rx inserts may be placed between the eyes and the screen 118. Presence of Rx inserts may be detected using the imaging device 116. As shown in the images 13A and 13B, there may be some differences due to refraction in the Rx insert. According to an embodiment of the disclosure, an AI module, such as a multi-layer perceptron (MLP) type neural network module may be trained to output the presence of Rx inserts by pattern recognition in an input to the MLP, wherein the input to the MLP may be images of the imaging device 116. The MLP may include a plurality of neural network layers. Each layer may have a plurality of weight values, and performs a layer operation through calculation of a previous layer and an operation of a plurality of weights.

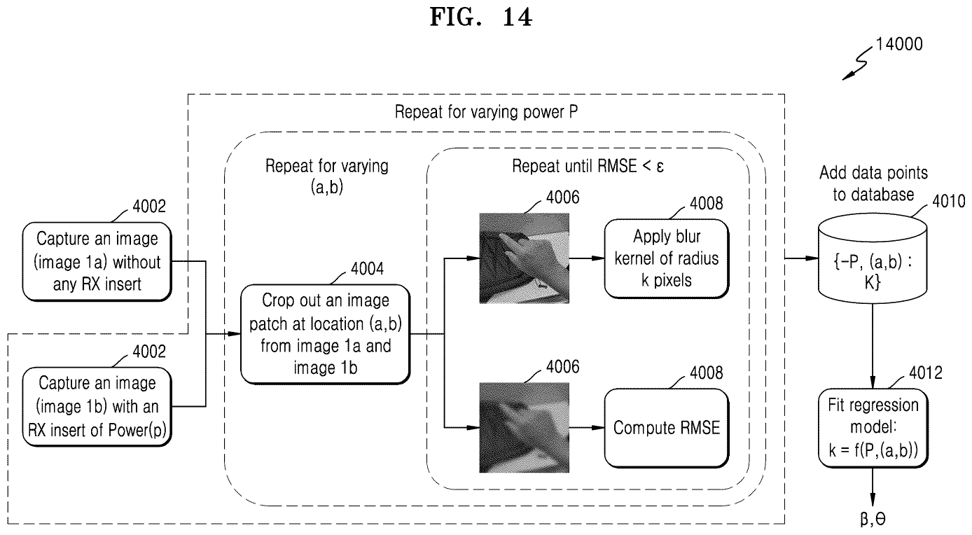

FIG. 14 illustrates a simplified flow diagram 14000 of a process of offline calibration for estimation of a blur kernel according to an embodiment of the disclosure.

Referring to FIG. 14, at block 4002, the imaging device 116 may capture the one or more first images of eyes for at least one of: the electronic device 100 with Rx insert of power P and the electronic device 100 without Rx insert.

At block 4004, the hand interaction controller 120 may crop out an image patch at location (a,b) from the images including at least one of: eye image with Rx insert of power P and eye image without Rx insert. At block 4006, the hand interaction controller 120 may obtain at least one of: the clean patch of user's hand for the user without Rx inserts and the blurry patch of user's hand for a user with Rx inserts for defective eyes.

At block 4008, the hand interaction controller 120 may perform at least one of: applying the blur kernel of radius k pixels to the clean patch and computing Root mean square error (RMSE) for the blurry patch. This step for blurry patch may be continued until RMSE<ϵ. Further this step may be repeated for varying locations (a,b) of image and varying power of Rx inserts.

At block 4010, the hand interaction controller 120 may add data points {{−P,(a,b):k}, wherein the data points may include blur kernel of radius k pixels and the RMSE, which are determined for varying locations (a,b) of image and varying power of Rx inserts. At block 4012, the hand interaction controller 120 may compute a fit regression model with the datapoints {{−P,(a,b):k} to obtain, β,θ. The output of the fit regression model and an adjusted eye power of the user may be used to estimate a spatially varying Blur Kernel as k=f(P,a,b)).

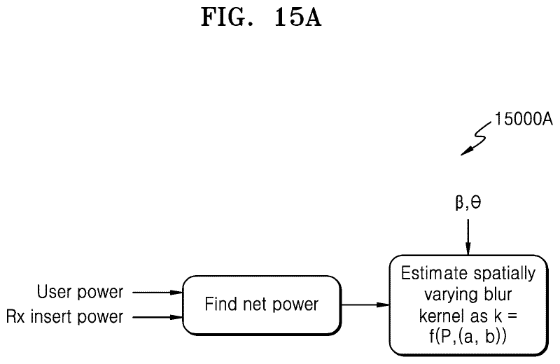

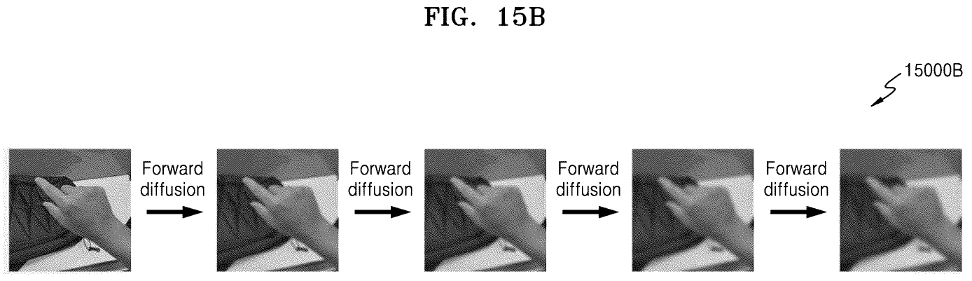

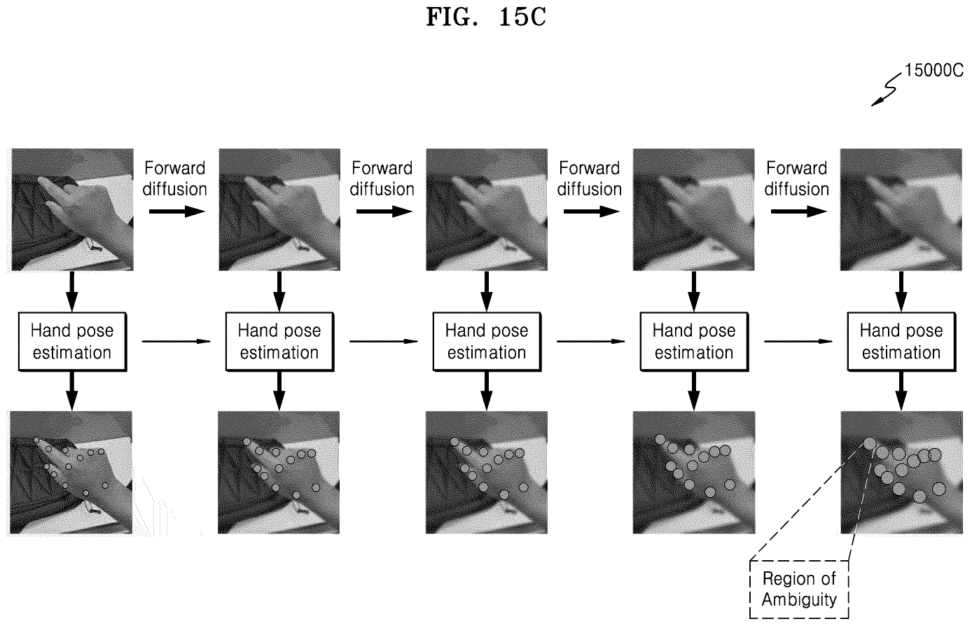

FIGS. 15A, 15B, and 15C illustrate a processes 15000A (including 15000A, 15000B, and 15000C) for a naturalized image generation and region of ambiguity detection, according to an embodiment of the disclosure.

Referring to FIGS. 15A, 15B, and 15C, a spatially varying Blur Kernel as k=f(P,a,b)) may be estimated by the hand interaction controller 120, from an adjusted eye power of the user and a fit regression model with input of, Rx insert power and image patch of user's hand. The process may be used to estimate, by the hand interaction controller 120, the diffused region of interaction perceived by the user with defective Rx insert. Using the estimated blur kernel, the process may be used to determine the blur perceived by the user. Further, the process may be used to progressively apply blur to the input image using the forward diffusion process. Further, the process may be used to estimate a region of ambiguity for each hand keypoint of the user's hand by performing hand tracking. Further, the process may be used to estimate hand keypoints and ray pointer on the blurred images progressively. The estimated hand keypoints and ray pointer may be provided to guide the same for the next iteration of the forward process. This iterative approach may enable to model the degradation perceived by the user in a progressive manner. The area of the regions of ambiguity may also increase as the image gets more blurred. Thus, the region of the ray pointer may also enlarge based on the estimated region of ambiguity.

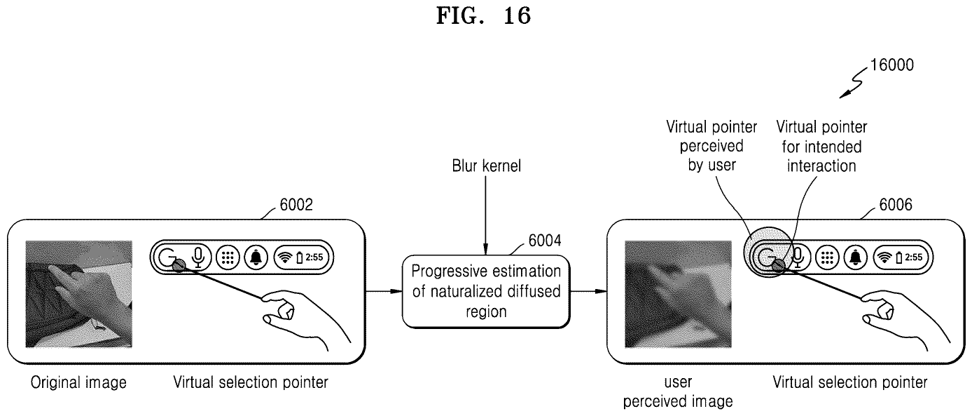

FIG. 16 depicts a process 16000 detection of a dynamic diffused region for a virtual selection pointer according to an embodiment of the disclosure.

Referring to FIG. 16, at operation 6002, the hand interaction controller 120 may identify the original hand image and corresponding virtual selection pointer 802 on the screen 118. At operation 6004, the hand interaction controller 120 may estimate progressively the naturalized diffused region associated with at least one second image, wherein the at least one second image may be a perceived hand image of user generated from at least one first image of original hand captured by the imaging device 116.

At operation 6006, the hand interaction controller 120 may estimate hand keypoints and virtual selection pointer 802 on the at least one second image (blurred image) progressively. According to an embodiment of the disclosure, the estimated hand keypoints and the virtual selection pointer 802 may be provided to guide the same for the next iteration of the forward process. The region of the virtual selection pointer 802 may also enlarge based on the estimated region of ambiguity. The user perceived image and corresponding virtual selection pointer 802 may be shown.

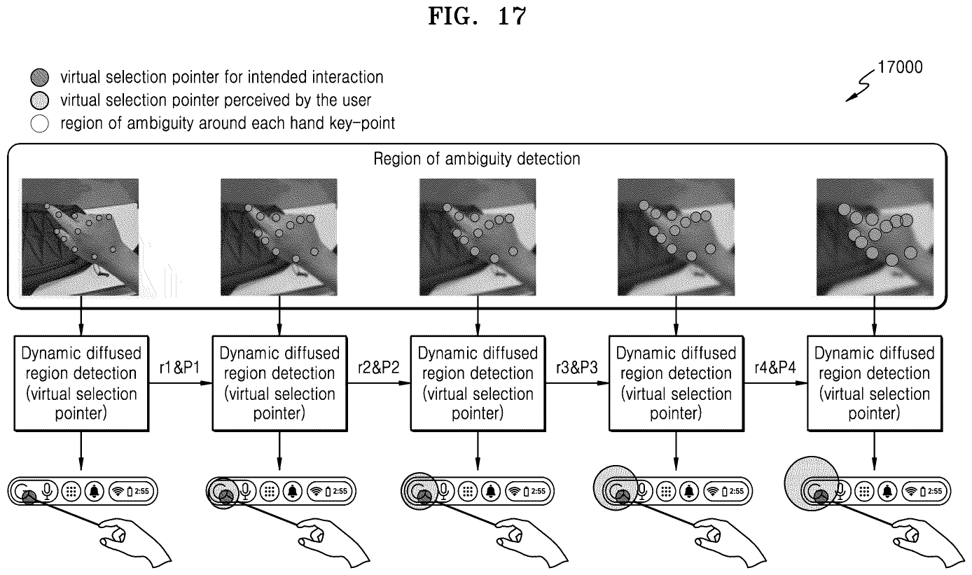

FIG. 17 is a schematic diagram 17000 depicting more enlarged dynamic diffused region as a perceived hand image becomes more blurred, according to an embodiment of the disclosure.

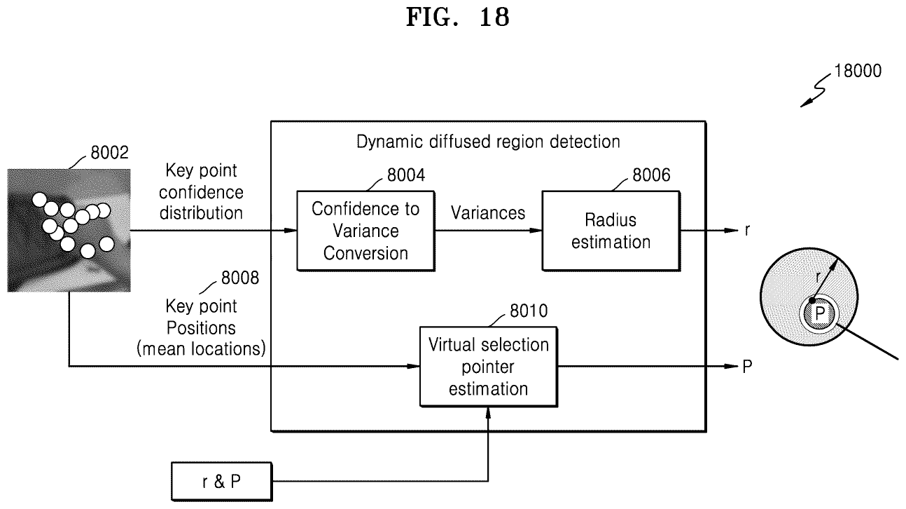

FIG. 18 depicts a process 18000 for modifying virtual selection pointer on a screen to substantially match a region of ambiguity around hand key point according to an embodiment of the disclosure.

Referring to FIGS. 17 and 18, at operation 8002, the hand interaction controller 120 may perform a plurality of hand keypoints confidence distribution.

At operation 8004, the hand interaction controller 120 may perform a conversion of the confidence distribution to variances. According to an embodiment of the disclosure, a variance Vk of keypoint k with confidence Ck may be given by, V_k=[(1−C_x)/V_max]. Where vmax is a predefined normalizing parameter.

At operation 8006, the hand interaction controller 120 may estimate radius of virtual selection pointer 802. According to an embodiment of the disclosure, the radius (r) of the virtual selection pointer 802 may be given by: r=2σ+1, where σ is σ=√(ΣV_k).

At operation 8008, the hand interaction controller 120 may perform detection of hand key-point position. At operation 8010, the hand interaction controller 120 may perform estimation of virtual selection pointer position.

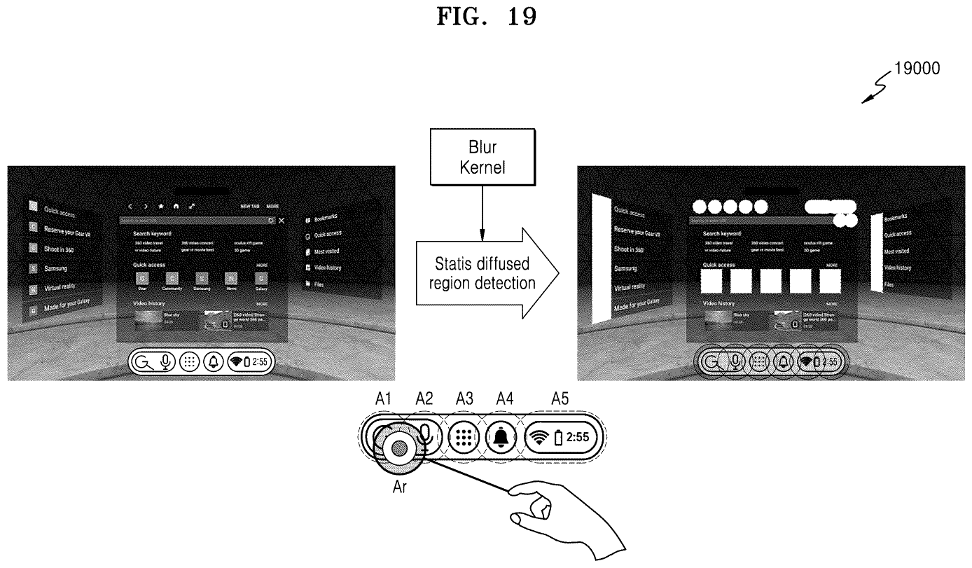

FIG. 19 illustrates a schematic diagram 19000 of static diffused region detection on UI elements and a diffused region overlap estimation according to an embodiment of the disclosure.

Referring to FIG. 19, based on the estimated blur kernel, all UX elements displayed on the screen 118, may be diffused by the hand interaction controller 120. Further, based on the diffusion, an area around each of the UX element may be determined. This area may need to be calculated only once whenever a new UX element is displayed on the screen 118. The static diffused regions may be then used to determine overlap with the dynamic diffused region 804 of the ray pointer which is used for selection of an UI element.

The area of overlap between the diffused ray pointer and the static diffused region of the UX elements may be calculated. According to an embodiment of the disclosure, the hand interaction controller 120 may first calculates the area of overlap between a dark Gray color circle and all the light Gray color circles.

$$A \_ 1 r = A \_ 1 ⋂ A \_r$$

$$A \_ 2 r = A \_ 2 ⋂ A \_r$$

$$A \_ 3 r = A \_ 3 ⋂ A \_r = A \_ 4 r = A \_ 4 ⋂ A \_r = A \_ 5 r = A \_ 5 ⋂ A \_r = 0$$

$$A \_ 1 r > A \_ 2 r$$

Thus, the hand interaction controller 120 may see that the overlap is highest with the first UI element (G search icon (for an example)). In addition, the proposed method may determine if the overlap is greater than a minimum threshold.

$$A \_ 1 r > min\_ threshold$$

Finally, if a pinch is detected, the first icon may be selected.

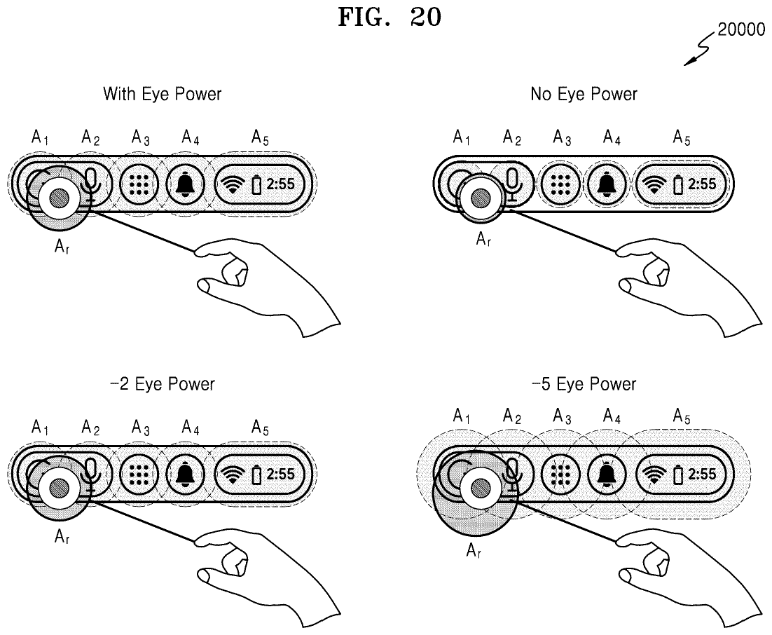

FIG. 20 illustrates a comparison 20000 of different user of an electronic device experiencing hand interaction with an electronic device according to an embodiment of the disclosure.

Referring to FIG. 20, in an example, the user may have an eye power and the region of selection, as well as the region of the virtual selection pointer 802 is bigger as compared to the UI element. In another example, the user may not have any eye power and has perfect vision. In this case, the region of selection, as well as the region of virtual selection pointer 802 may be of the same size as the UX element.

In another example, the user may have an eye power of −2. In this case, the region of selection as well as the region of the virtual selection pointer 802 may be slightly bigger than an UI element. In another example, the user may have an eye power of −5. In this case, the region of selection as well as the region of virtual selection pointer 802 may be very much bigger than an UI element.

Embodiments herein achieve methods and a system to estimate the user perceived eye power due to defects in Rx inserts placed in the electronic device 100. The method may include taking as input a history of the user's UI element selection history. Further, the method may include calculating from the history of user's UI element selection history, and the average distance of the ray pointer from the center of the UI element during selections. Further, the method may include calculating from the history of user's UI element selection history, and the average number of pinches required by the user to select the UI element. Further, the method may include estimating the user perceived eye power from the weighted sum of the calculated average distance and the calculated average number of pinches.

The method may be used to improve the hand interactions in the electronic device 100 for the users with eye power. The method may be used to detect the presence of Rx inserts and their defects if present. The method may use the proposed techniques to naturalize the input image such that the electronic device 100 also sees the hand images similar to how the user would perceive them without the eye power correction. The method may then diffuse the UI elements as well as the virtual selection pointer regions, and estimates an overlap region resulting in selection interaction with the UI elements.

With the proposed methods, the user's vision may be perfect. Even when the Rx inserts are defective, the users may still have a seamless user interaction with the electronic device 100. The method may be used to detect Rx insert defects and determine the effective eye power of the user with the Rx insert. Using this effective eye power, the method may be used to improve the interaction experience of the user.

Embodiments of the disclosure disclose, interaction experience of the users may degrade if they have eye power and are not using Rx inserts. The proposed method may be used to firstly identify whether the Rx inserts are placed or not. Based on the detection, if the user with eye power is not using the Rx inserts, the proposed method may be used to improve their interaction experience. The method may be used to detect the diffused region around a ray pointer (virtual pointer) dynamically. The method may be used to detect the diffused region around the UI elements. The diffused region may be that area around an element where there is confusion on where the element is due to degraded vision. Further, the method may be used to define a blur kernel based on the user's eye power and apply it to the UI elements to get their diffused region. The method may be used to apply the above kernel on input images and perform hand tracking to detect the dynamic diffused region 804 around the ray pointer. The method may be used to perform this on alternate frames while running normal hand tracking on the other frames. Once the method has both the diffused regions, the method may be used to detect selection based on overlap.

Some features may be considered while making the choice of selection, such as enough overlapping between the diffused region around the ray pointer and the diffused region around the UI element, if there are multiple diffused regions of UI elements overlapping with the diffused region around the ray pointer, and if there is enough overlap to conclusively say which UI element the user wants to select.

Embodiments of the disclosure may disclose Rx insert detection in the electronic device 100. The imaging device 116 may be used to capture eye movement of the user. The Rx inserts may be placed between the eyes and the electronic device 100. The Rx insert presence may be detected using the imaging device 116. There may be some differences due to refraction in the Rx insert. A Multi-Layer Perception may be trained to output the presence of Rx inserts using the eye tracking camera images as input.

Embodiments of the disclosure may disclose detecting Rx insert defect. In order to estimate the defects in the Rx inserts, the method may use the context of the user in virtual reality (VR) as well as their selection history. The user context may be estimating what the user wants to select based on the recent history of user interactions. The selection history may consist of the following user data, such as average distance of ray pointer from the center of the UI element during selections, and the average number of pinches required by the user to select a UI element (the user of the electronic device 100 knows that the user of the UI element is trying to select based on user context). If Rx insert has defects, the user may take multiple tries to select the UI element and the average distance of ray pointer from the center of the UI element during selections will be high.

According to an embodiment of the disclosure, the method may be used to naturalize the input image such that the electronic device 100 also sees the hand images similar to how the user would perceive them without the eye power correction. According to an embodiment of the disclosure, the method may be used to diffuse the UI elements as well as the virtual selection pointer regions and estimate an overlap region resulting in selection interaction with the UI elements.

According to an embodiment of the disclosure, the method may be used to interact with the HMD assuming that the user is able to see the display perfectly.

According to an embodiment of the disclosure, if the user has eye power, the user may be expected to use Rx inserts without any defects that help the user view the electronic device display as if they have no eye defects. According to an embodiment of the disclosure, the proposed method may be used with any HMD or XR or AR device where the primary form of interaction is through hands.

According to an embodiment of the disclosure, the method may be used to customize the interaction experience to the user based on the user's eye power and the Rx insert being used. According to an embodiment of the disclosure, the method may be used to enable at-least 5× improvement in the user-experience of the device for users with eye defects.

According to an embodiment of the disclosure, a method for managing hand interaction of a user on a screen of an electronic device may be provided. The method may include comparing, by the electronic device, an original hand data and a perceived hand data to identify at least one uncertain input zone in the screen of the electronic device. The method may include identifying, by the electronic device, a pointer, wherein the pointer is representative of a finger of the user pointing towards at least one of: a first user interface (UI) element, and a second UI element in the at least one identified uncertain input zone in the screen. The method may include modifying, by the electronic device, a size of the pointer based on a size of the at least one identified uncertain input zone. The method may include determining, by the electronic device, an extent of an overlap of the modified pointer with at least one of: the first UI element, and the second UI element. The method may include selecting and activating, by the electronic device, at least one of: the first UI element, and the second UI element that has a maximum overlap with the modified pointer.

According to an embodiment of the disclosure, the comparing, by the electronic device, the original hand data and the perceived hand data to identify the at least one uncertain input zone may comprise capturing, by the electronic device, the original hand data indicating an original hand position of the user. The comparing, by the electronic device, the original hand data and the perceived hand data to identify the at least one uncertain input zone may comprise generating, by the electronic device, the perceived hand data indicating a perceived hand position of the user. The comparing, by the electronic device, the original hand data and the perceived hand data to identify the at least one uncertain input zone may comprise comparing, by the electronic device, the original hand data, and the perceived hand data to identify the at least one uncertain input zone.

According to an embodiment of the disclosure, at least one of: the original hand data indicating the original hand position of the user, and the perceived hand data indicating the perceived hand position of the user may be estimated based on a perception kernel.

According to an embodiment of the disclosure, the perception kernel may be estimated by obtaining, by the electronic device, an eye power input indicating an eye power of the user. The perception kernel may be estimated by obtaining, by the electronic device, at least one eye input image from an imaging device. The perception kernel may be estimated by determining, by the electronic device, that an insert is detected using the at least one eye input image and the eye power of the user. The perception kernel may be estimated by determining, by the electronic device, a defect in the detected insert. The perception kernel may be estimated by computing, by the electronic device, an insert power using an original eye power and the determined defect in the detected insert. The perception kernel may be estimated by computing, by the electronic device, a blur kernel for the perception using the user eye power and the computed insert power.

According to an embodiment of the disclosure, the perception kernel may be estimated by obtaining, by the electronic device, an eye power input indicating an eye power corresponding to the user. The perception kernel may be estimated by obtaining, by the electronic device, at least one eye input image from an imaging device. The perception kernel may be estimated by determining, by the electronic device, whether an insert is detected using the at least one eye input image and the eye power of the user. The perception kernel may be estimated by determining, by the electronic device, that the insert power as zero upon determining that the insert is not detected. The perception kernel may be estimated by computing, by the electronic device, a blur kernel for the perception using the user eye power based on the determination.

According to an embodiment of the disclosure, the perceived hand position of the user may be determined based on a perceived eye power due to the defect in the insert placed in the electronic device. The perceived eye power may be determined by obtaining, by the electronic device, an input comprising a UI element selection history of the user. The perceived eye power may be determined by computing, by the electronic device, an average distance of a virtual selection pointer from a center of the UI element, from the UI element selection history, during selection. The perceived eye power may be determined by computing, by the electronic device, an average number of pinches required by the user to select the UI element from the history of UI element selection history. The perceived eye power may be determined by determining, by the electronic device, the user perceived eye power from a weighted sum of the computed average distance and the computed average number of pinches.

According to an embodiment of the disclosure, the modifying by the electronic device, the pointer to the size that substantially matches with the size of the at least one identified uncertain input zone may comprise estimating hand key point and a virtual selection pointer from a blurred image. The modifying by the electronic device, the pointer to the size that substantially matches with the size of the at least one identified uncertain input zone may comprise using the estimated hand key point and the virtual selection pointer to guide estimation in at least one subsequent iteration process. The at least one subsequent iteration process enable a user to model a degradation perceived by the user, wherein an area of the at least one identified uncertain input zone increases as the image gets more blurred. The modifying by the electronic device, the pointer to the size that substantially matches with the size of the at least one identified uncertain input zone may comprise modifying by the electronic device, the pointer to the size that substantially matches with the size of the at least one identified uncertain input zone based on the estimation.

According to an embodiment of the disclosure, the first UI element and the second UI element may be adjacent to each other in the at least one uncertain input zone.

According to an embodiment of the disclosure, a method for managing hand interaction of a user on a screen of an electronic device may be provided. The method may include obtaining, by the electronic device, at least one first image associated with a hand captured by the electronic device and an eye power prescription of the user. The method may include generating, by the electronic device, at least one second image of the hand by correlating the at least one first image and the eye power prescription. The method may include estimating, by the electronic device, a region of ambiguity for each key point of the hand by performing hand tracking of user's hand using the at least one generated second image. The method may include modifying, by the electronic device, a region of a virtual selection pointer based on the estimated region of ambiguity. The method may include performing, by the electronic device, the hand interaction with at least one user interface (UI) element based on an extent of overlap between the modified region of the virtual selection pointer and a region of selection associated with the at least one UI element.

According to an embodiment of the disclosure, at least one of: at least one first image indicating an original hand position of the user and the at least one second image indicating a perceived hand position of the user may be estimated based on a perception kernel.

According to an embodiment of the disclosure, the perception kernel may be estimated by obtaining, by the electronic device, an eye power input indicating an eye power of the user. The perception kernel may be estimated by obtaining, by the electronic device, at least one eye input image from an imaging device. The perception kernel may be estimated by determining, by the electronic device, that an insert is detected using the at least one eye input image and the eye power of the user. The perception kernel may be estimated by determining, by the electronic device, a defect in the detected insert. The perception kernel may be estimated by computing, by the electronic device, a new insert power using an original eye power and determined defect in the insert. The perception kernel may be estimated by computing, by the electronic device, a blur kernel for the perception using the user eye power and the computed new insert power.

According to an embodiment of the disclosure, the perception kernel may be estimated by obtaining, by the electronic device, an eye power input indicating an eye power corresponding to the user. The perception kernel may be estimated by obtaining, by the electronic device, at least one eye input image from an imaging device. The perception kernel may be estimated by determining, by the electronic device, whether an insert is detected using the at least one eye input image and the eye power of the user. The perception kernel may be estimated by determining, by the electronic device, that the insert power as zero upon determining that the insert is not detected. The perception kernel may be estimated by computing, by the electronic device, a blur kernel for the perception using the user eye power based on the determination.

According to an embodiment of the disclosure, the at least one first image associated with the hand captured by the electronic device and the eye power prescription of the user may be obtained in response to an initiation of at least one hand interaction of the user with at least one UI element rendered by the electronic device.

According to an embodiment of the disclosure, the at least one hand interaction may be initiated using the virtual selection pointer. The at least one second image of hand may represent a visual perception of the at least one first image of the hand.

According to an embodiment of the disclosure, the modifying, by the electronic device, the region of the virtual selection pointer based on the estimated region of ambiguity may include estimating a hand key point and the virtual selection pointer from a blurred image. The modifying, by the electronic device, the region of the virtual selection pointer based on the estimated region of ambiguity may include using the estimated hand key point and the virtual selection pointer to guide estimation in at least one subsequent iteration process. The at least one subsequent iteration process may enable a user to model a degradation perceived by the user. An area of the at least one identified uncertain input zone may increase as the image gets blurred. The modifying, by the electronic device, the region of the virtual selection pointer based on the estimated region of ambiguity may include modifying by the electronic device, the region of the virtual selection pointer based on the estimated region of ambiguity.

According to an embodiment of the disclosure, an electronic device may be provided. The electronic device may include a processor; a screen; a memory; and a hand interaction controller. The hand interaction controller may be coupled with the processor and memory. The hand interaction controller may be configured to compare an original hand data and a perceived hand data to identify at least one uncertain input zone in the screen of the electronic device. The hand interaction controller may be configured to identify a pointer representative of a finger of the user pointing towards at least one of: a first user interface (UI) element and a second UI element in the at least one identified uncertain input zone in the screen. The hand interaction controller may be configured to modify a size of the pointer based on a size of the at least one identified uncertain input zone. The hand interaction controller may be configured to determine an extent of an overlap of the modified pointer with at least one of: the first UI element and the second UI element. The hand interaction controller may be configured to select and activate at least one of: the first UI element and the second UI element that has a maximum overlap with the modified pointer.

According to an embodiment of the disclosure, an electronic device may be provided. The electronic device may include a processor; a screen; a memory; and a hand interaction controller. The hand interaction controller may be coupled with the processor and memory. The hand interaction controller may be configured to obtain at least one first image associated with a hand captured by the electronic device and an eye power prescription of the user. The hand interaction controller may be configured to generate at least one second image of the hand by correlating the at least one first image and the eye power prescription, wherein the at least one second image of hand represents a visual perception of the first images of the hand. The hand interaction controller may be configured to estimate a region of ambiguity for each key point of the hand by performing hand tracking of user's hand using the at least one generated second image. The hand interaction controller may be configured to modify a region of a virtual selection pointer based on the estimated region of ambiguity. The hand interaction controller may be configured to perform the hand interaction with the at least one UI element based on an extent of overlap between the modified region of the virtual selection pointer and a region of selection associated with the at least one UI element.

According to an embodiment of the disclosure, the comparing of the original hand data and the perceived hand data to identify the at least one uncertain input zone may include capturing the original hand data indicating an original hand position of the user. The comparing of the original hand data and the perceived hand data to identify the at least one uncertain input zone may include generating the perceived hand data indicating a perceived hand position of the user.

According to an embodiment of the disclosure, the perception kernel may be estimated by obtaining an eye power input indicating an eye power of the user. The perception kernel may be estimated by obtaining at least one eye input image from an imaging device. The perception kernel may be estimated by determining that an insert is detected using the at least one eye input image and the eye power of the user. The perception kernel may be estimated by determining a defect in the detected insert. The perception kernel may be estimated by computing an insert power using an original eye power and the determined defect in the detected insert. The perception kernel may be estimated by computing a blur kernel for a perception using the eye power of the user and the computed insert power.

According to an embodiment of the disclosure, the perception kernel may be estimated by obtaining an eye power input indicating an eye power of the user. The perception kernel may be estimated by obtaining at least one eye input image from an imaging device. The perception kernel may be estimated by determining that an insert is detected using the at least one eye input image and the eye power of the user. The perception kernel may be estimated by determining that an insert power as zero upon determining that the insert is not detected. The perception kernel may be estimated by computing a blur kernel for a perception using the eye power of the user based on the determination.

According to an embodiment of the disclosure, the perceived hand position of the user may be determined based on a perceived eye power due to the defect in the insert placed in the electronic device. The perceived eye power may be determined by obtaining an input comprising a UI element selection history of the user. The perceived eye power may be determined by computing an average distance of a virtual selection pointer from a center of the UI element, from the UI element selection history, during selection. The perceived eye power may be determined by computing an average number of pinches required by the user to select the UI element from the UI element selection history. The perceived eye power may be determined by determining the perceived eye power from a weighted sum of the computed average distance and the computed average number of pinches.

According to an embodiment of the disclosure, the modifying of the size of the pointer based on the size of the at least one identified uncertain input zone may include estimating hand key point and a virtual selection pointer from a blurred image. The modifying of the size of the pointer based on the size of the at least one identified uncertain input zone may include using the estimated hand key point and the virtual selection pointer for estimation in at least one subsequent iteration process, wherein the at least one subsequent iteration process indicates a modeling a degradation perceived by the user, wherein an area of the at least one uncertain input zone increases as image gets more blurred. The modifying of the size of the pointer based on the size of the at least one identified uncertain input zone may include modifying the pointer to the size that matches with the size of the at least one identified uncertain input zone based on the estimation.

According to an embodiment of the disclosure, the method may include obtaining at least one first image associated with a hand captured by the electronic device and an eye power prescription of the user. The method may include generating at least one second image of the hand by correlating the at least one first image and the eye power prescription. The at least one second image may indicate a visual perception of the at least one first image. The method may include estimating a region of ambiguity for each key point of the hand by performing hand tracking using the generated at least one second image. The method may include modifying a region of the virtual selection pointer based on the estimated region of ambiguity. The method may include performing a hand interaction with at least one UI element based on the extent of the overlap between the modified region of the virtual selection pointer and a region of selection associated with the at least one UI element.

According to an embodiment of the disclosure, the at least one instruction, when executed by the at least one processor individually or collectively, causes the electronic device to capture the original hand data indicating an original hand position of the user. The at least one instruction, when executed by the at least one processor individually or collectively, causes the electronic device to generate the perceived hand data indicating a perceived hand position of the user.

According to an embodiment of the disclosure, at least one of the original hand data indicating the original hand position of the user, or the perceived hand data indicating the perceived hand position of the user may be estimated based on a perception kernel.

According to an embodiment of the disclosure, the perception kernel may be estimated by obtaining an eye power input indicating an eye power of the user. The perception kernel may be estimated by obtaining at least one eye input image from an imaging device. The perception kernel may be estimated by determining that an insert is detected using the at least one eye input image and the eye power of the user. The perception kernel may be estimated by determining a defect in the detected insert. The perception kernel may be estimated by computing an insert power using an original eye power and the determined defect in the detected insert. The perception kernel may be estimated by computing a blur kernel for a perception using the eye power of the user and the computed insert power.

According to an embodiment of the disclosure, the perception kernel is estimated by obtaining an eye power input indicating an eye power of the user. The perception kernel may be estimated by obtaining at least one eye input image from an imaging device. The perception kernel may be estimated by determining that an insert is detected using the at least one eye input image and the eye power of the user. The perception kernel may be estimated by determining that an insert power as zero upon determining that the insert is not detected. The perception kernel may be estimated by computing a blur kernel for a perception using the eye power of the user based on the determination.

According to an embodiment of the disclosure, the perceived hand position of the user may be determined based on a perceived eye power due to the defect in the insert placed in the electronic device. The perceived eye power may be determined by obtaining an input comprising a UI element selection history of the user. The perceived eye power may be determined by computing an average distance of a virtual selection pointer from a center of the UI element, from the UI element selection history, during selection. The perceived eye power may be determined by computing an average number of pinches required by the user to select the UI element from the UI element selection history. The perceived eye power may be determined by determining the perceived eye power from a weighted sum of the computed average distance and the computed average number of pinches.

According to an embodiment of the disclosure, the at least one instruction, when executed by the at least one processor individually or collectively, causes the electronic device to estimate hand key point and a virtual selection pointer from a blurred image. The at least one instruction, when executed by the at least one processor individually or collectively, causes the electronic device to use the estimated hand key point and the virtual selection pointer for estimation in at least one subsequent iteration process, wherein the at least one subsequent iteration process indicates a modeling a degradation perceived by the user, wherein an area of the at least one uncertain input zone increases as image gets more blurred. The at least one instruction, when executed by the at least one processor individually or collectively, causes the electronic device to modify the pointer to the size that matches with the size of the at least one identified uncertain input zone based on the estimation.

According to an embodiment of the disclosure, the first UI element and the second UI element may be adjacent to each other in the at least one uncertain input zone.

According to an embodiment of the disclosure, the at least one instruction, when executed by the at least one processor individually or collectively, further causes the electronic device to obtain at least one first image associated with a hand captured by the electronic device and an eye power prescription of the user. The at least one instruction, when executed by the at least one processor individually or collectively, further causes the electronic device to generate at least one second image of the hand by correlating the at least one first image and the eye power prescription. The at least one second image may indicate a visual perception of the at least one first image. The at least one instruction, when executed by the at least one processor individually or collectively, further causes the electronic device to estimate a region of ambiguity for each key point of the hand by performing hand tracking using the generated at least one second image. The at least one instruction, when executed by the at least one processor individually or collectively, further causes the electronic device to modify a region of the virtual selection pointer based on the estimated region of ambiguity. The at least one instruction, when executed by the at least one processor individually or collectively, further causes the electronic device to perform a hand interaction with at least one UI element based on the extent of the overlap between the modified region of the virtual selection pointer and a region of selection associated with the at least one UI element.

The various actions in FIGS. 3 to 12, 13A, 13B, 13C, 13D, 14, 15A, 15B, 15C, and 16 to 19 may be performed in the order presented, in a different order or simultaneously. Further, in some embodiments of the disclosure, some actions listed in figures may be omitted.

The embodiments disclosed herein can be implemented through at least one software program running on at least one hardware device and performing network management functions to control the network elements. The elements include blocks which can be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an application specific integrated circuit (ASIC), or a combination of hardware and software means, e.g., an ASIC and a field programmable gate array (FPGA), or at least one microprocessor and at least one memory with software modules located therein. The method embodiments described herein could be implemented partly in hardware and partly in software. Alternatively, the disclosure may be implemented on different hardware devices, e.g., using a plurality of CPUs.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
comparing original hand data and perceived hand data to identify at least one uncertain input zone in a screen of the electronic device;
identifying a pointer indicating a finger of a user pointing towards at least one of a first user interface (UI) element, or a second UI element in the at least one identified uncertain input zone;
modifying a size of the pointer based on a size of the at least one identified uncertain input zone;
determining an extent of an overlap of the pointer with at least one of the first UI element, or the second UI element; and
selecting and activating at least one of the first UI element, or the second UI element that has a maximum overlap with the pointer.

2. The method of claim 1, wherein the comparing of the original hand data and the perceived hand data to identify the at least one uncertain input zone comprises:
capturing the original hand data indicating an original hand position of the user; and
generating the perceived hand data indicating a perceived hand position of the user.

3. The method of claim 2, wherein at least one of the original hand data indicating the original hand position of the user, or the perceived hand data indicating the perceived hand position of the user is estimated based on a perception kernel.

4. The method of claim 3, wherein the perception kernel is estimated by:
obtaining an eye power input indicating an eye power of the user;
obtaining at least one eye input image from an imaging device;
determining that an insert is detected using the at least one eye input image and the eye power of the user;
determining a defect in the detected insert;
computing an insert power using an original eye power and the determined defect in the detected insert; and
computing a blur kernel for a perception using the eye power of the user and the computed insert power.

5. The method of claim 4, wherein the perception kernel is estimated by:
obtaining an eye power input indicating an eye power of the user;
obtaining at least one eye input image from an imaging device;
determining that an insert is detected using the at least one eye input image and the eye power of the user;
determining that an insert power as zero upon determining that the insert is not detected; and
computing a blur kernel for a perception using the eye power of the user based on the determination.

6. The method of claim 5,
wherein the perceived hand position of the user is determined based on a perceived eye power due to the defect in the insert placed in the electronic device, and
wherein the perceived eye power is determined by:
obtaining an input comprising a UI element selection history of the user;
computing an average distance of a virtual selection pointer from a center of the UI element, from the UI element selection history, during selection;
computing an average number of pinches required by the user to select the UI element from the UI element selection history; and
determining the perceived eye power from a weighted sum of the computed average distance and the computed average number of pinches.

7. The method of claim 6, wherein the modifying of the size of the pointer based on the size of the at least one identified uncertain input zone comprises:
estimating hand key point and a virtual selection pointer from a blurred image;
using the estimated hand key point and the virtual selection pointer for estimation in at least one subsequent iteration process, wherein the at least one subsequent iteration process indicates a modeling a degradation perceived by the user, wherein an area of the at least one uncertain input zone increases as image gets more blurred; and
modifying the pointer to the size that matches with the size of the at least one identified uncertain input zone based on the estimation.

8. The method of claim 7, wherein the first UI element and the second UI element are adjacent to each other in the at least one uncertain input zone.

9. The method of claim 8, further comprising:
obtaining at least one first image associated with a hand captured by the electronic device and an eye power prescription of the user;
generating at least one second image of the hand by correlating the at least one first image and the eye power prescription, wherein the at least one second image indicates a visual perception of the at least one first image;
estimating a region of ambiguity for each key point of the hand by performing hand tracking using the generated at least one second image;
modifying a region of the virtual selection pointer based on the estimated region of ambiguity; and
performing a hand interaction with at least one UI element based on the extent of the overlap between the modified region of the virtual selection pointer and a region of selection associated with the at least one UI element.

10. The method of claim 9, wherein at least one of the at least one first image indicating the original hand position of the user, or the at least one second image indicating the perceived hand position of the user is estimated based on the perception kernel.

11. An electronic device comprising:
memory storing at least one instruction; and
at least one processor operatively coupled with the memory and comprising processing circuitry,
wherein the at least one instruction, when executed by the at least one processor individually or collectively, causes the electronic device to:
compare original hand data and perceived hand data to identify at least one uncertain input zone in a screen of the electronic device,
identify a pointer indicating a finger of a user pointing towards at least one of a first user interface (UI) element or a second UI element in the at least one identified uncertain input zone in the screen,
modify a size of the pointer based on a size of the at least one identified uncertain input zone,
determine an extent of an overlap of the pointer with at least one of the first UI element or the second UI element, and
select and activate at least one of the first UI element or the second UI element that has a maximum overlap with the pointer.

12. The electronic device of claim 11, wherein the at least one instruction, when executed by the at least one processor individually or collectively, causes the electronic device to:
capture the original hand data indicating an original hand position of the user, and
generate the perceived hand data indicating a perceived hand position of the user.

13. The electronic device of claim 12, wherein at least one of the original hand data indicating the original hand position of the user, or the perceived hand data indicating the perceived hand position of the user is estimated based on a perception kernel.

14. The electronic device of claim 13, wherein the perception kernel is estimated by:
obtaining an eye power input indicating an eye power of the user;
obtaining at least one eye input image from an imaging device;
determining that an insert is detected using the at least one eye input image and the eye power of the user;
determining a defect in the detected insert;
computing an insert power using an original eye power and the determined defect in the detected insert; and
computing a blur kernel for a perception using the eye power of the user and the computed insert power.

15. The electronic device of claim 13, wherein the perception kernel is estimated by:
obtaining an eye power input indicating an eye power of the user;
obtaining at least one eye input image from an imaging device;
determining that an insert is detected using the at least one eye input image and the eye power of the user;
determining that an insert power as zero upon determining that the insert is not detected; and
computing a blur kernel for a perception using the eye power of the user based on the determination.

16. The electronic device of claim 15,
wherein the perceived hand position of the user is determined based on a perceived eye power due to the defect in the insert placed in the electronic device, and
wherein the perceived eye power is determined by:
obtaining an input comprising a UI element selection history of the user;
computing an average distance of a virtual selection pointer from a center of the UI element, from the UI element selection history, during selection;
computing an average number of pinches required by the user to select the UI element from the UI element selection history; and
determining the perceived eye power from a weighted sum of the computed average distance and the computed average number of pinches.

17. The electronic device of claim 16, wherein the at least one instruction, when executed by the at least one processor individually or collectively, causes the electronic device to:
estimate hand key point and a virtual selection pointer from a blurred image,
use the estimated hand key point and the virtual selection pointer for estimation in at least one subsequent iteration process, wherein the at least one subsequent iteration process indicates a modeling a degradation perceived by the user, wherein an area of the at least one uncertain input zone increases as image gets more blurred, and
modify the pointer to the size that matches with the size of the at least one identified uncertain input zone based on the estimation.

18. The electronic device of claim 17, wherein the first UI element and the second UI element are adjacent to each other in the at least one uncertain input zone.

19. The electronic device of claim 18, wherein the at least one instruction, when executed by the at least one processor individually or collectively, causes the electronic device to:
obtain at least one first image associated with a hand captured by the electronic device and an eye power prescription of a user,
generate at least one second image of the hand by correlating the at least one first image and the eye power prescription, wherein the at least one second image indicates a visual perception of the at least one first image,
estimate a region of ambiguity for each key point of the hand by performing hand tracking using the generated at least one second image,
modify a region of the virtual selection pointer based on the estimated region of ambiguity, and
perform a hand interaction with at least one UI element based on the extent of the overlap between the modified region of the virtual selection pointer and a region of selection associated with the at least one UI element.

20. One or more non-transitory computer-readable storage media storing one or more computer programs including computer-executable instruction that, when executed by one or more processors of an electronic device individually or collectively, cause the electronic device to perform the method of claim 1.
